(19) United States
(12) Patent Application Publication
(10) Pub. No.: US 2023/0153740 A1
(43) Pub. Date: May 18, 2023

(54) SYSTEMS, METHODS, AND APPARATUSES FOR USING MACHINE LEARNING TO CATEGORIZE AND SELECT SUGGESTED SOURCE ENTITIES

(71) Applicant: Premier Healthcare Solutions, Inc., Charlotte, NC (US)

(72) Inventors: Mickey Meehan, Walnut Creek, CA (US); Michael William Regan, Danville, CA (US); Matthew Joseph Erhart, Berkeley, CA (US); David Beard, Wilmington, NC (US); Bill Sambrone, Walnut Creek, CA (US); Chris Gormley, Guilford, CT (US); Nicole Barker, Walnut Creek, CA (US); Anna Ormiston, Walnut Creek, CA (US)

(73) Assignee: Premier Healthcare Solutions, Inc., Charlotte, NC (US)

(21) Appl. No.: 18/096,395

(22) Filed: Jan. 12, 2023

Related U.S. Application Data
(63) Continuation-in-part of application No. 16/894,360, filed on Jun. 5, 2020.
Application No. 16/894,360 is a continuation-in-part of application No. 16/918,075, filed on Jul. 1, 2020.
(60) Provisional application No. 62/858,817, filed on Jun. 7, 2019.
(60) Provisional application No. 62/869,398, filed on Jul. 1, 2019.

(51) Int. Cl. G06Q 10/0639; G06Q 30/018; G06F 40/40

(52) U.S. Cl. CPC G06Q 10/06395; G06Q 30/018; G06F 40/40

(57) ABSTRACT

The present invention relates to providing systems, methods, and apparatuses for using machine learning to categorize and select suggested source entities. In some embodiments, such a system may comprise receiving a resource file from a user; normalizing the at least one supplier entity name to generate at least one normalized supplier entity name; determining the at least one normalized supplier entity name matches an authenticated supplier entity name of an entity name master record; updating a source entity management database; receiving a user indication; applying the at least one pre-determined variable standard and the selected category to a source entity suggestion model to output at least one suggested source entity name that matches the pre-determined variable standard and the selected category; and generating a suggested source entity interface component to configure a graphical user interface of a user device associated with the user.

### CROSS-REFERENCE TO PRIORITY APPLICATION

This application claims priority to and the benefit of U.S. Non-Provisional patent application Ser. No. 16/894,360, filed Jun. 5, 2020, entitled “Method And Process For Using Machine Learning To Categorize Service Suppliers,” which claims priority to and the benefit of U.S. Provisional Patent Application Ser. No. 62/858,817, filed Jun. 7, 2019 entitled “Method and Process for using Machine Learning to categorize Service Suppliers,” which are incorporated by reference in their entirety. Additionally, this application claims priority to and the benefit of U.S. Non-Provisional patent application Ser. No. 16/918,075, filed Jul. 1, 2020, entitled “Method And System For Managing Supplier For Healthcare Organizations,” which claims priority to and the benefit of U.S. Provisional Patent Application Ser. No. 62/869,398, filed Jul. 1, 2019, entitled “Method And System For Managing Supplier Healthcare Organizations,” which are hereby incorporated by reference in their entirety.

### FIELD OF THE DISCLOSURE

The present invention relates to systems, methods, and apparatuses for using machine learning to categorize and select suggested source entities.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

In an aspect of the invention, a system for using machine learning to categorize and select suggested source entities is provided. In an embodiment of the invention, the system may comprise: a memory device with computer-readable program code stored thereon; at least one processing device operatively coupled to the at least one memory device and the at least one communication device, wherein executing the computer-readable code is configured to cause the at least one processing device to: receive a resource file from a user, the resource file comprising at least one supplier entity name and at least one resource line item; sort at least one resource line item in the resource file based on the at least one supplier entity name; normalize the at least one supplier entity name to generate at least one normalized supplier entity name; determine the at least one normalized supplier entity name matches an authenticated supplier entity name of an entity name master record; update, based on the normalized supplier entity name, a source entity management database, wherein the source entity management database comprises a plurality of authenticated supplier entity names and a plurality of previous variable data for each of the authenticated supplier entity names and at least one updated variable data for the normalized supplier entity name; receive a user indication, wherein the user indication comprises at least one pre-determined variable standard and a selected category; apply the at least one pre-determined variable standard and the selected category to a source entity suggestion model to output at least one suggested source entity name that matches the pre-determined variable standard and the selected category; and generate, based on the at least one suggested source entity name, a suggested source entity interface component to configure a graphical user interface of a user device associated with the user.

In some embodiments, and where the at least one normalized supplier entity name matches an authenticated supplier entity name, the system may categorize the at least one supplier entity name in an identified category associated with the authenticated supplier entity name.

In some embodiments, the processing device may further be configured to: receive at least one resource agreement between a supplier entity and a user; and apply an agreement engine to the at least one resource agreement, wherein the agreement engine outputs at least one key performance indicator of the resource agreement and automatically updates the source entity management database with the key performance indicators, wherein at least one key performance indicator is at least one updated variable data for the supplier entity.

In some embodiments, and in an instance where at least one supplier entity name does not match an authenticated supplier entity name, the system may apply a supplier entity name machine learning model to the at least one supplier entity name. In some embodiments, and wherein, in the instance where the at least one supplier entity name does not match an authenticated supplier entity name, the at least one processing device may further be configured to: search the at least one supplier entity name in a user database, the user database comprising a plurality of authenticated supplier entity names and at least one associated category for each authenticated supplier entity name of the user database; generate a determined result based on the at least one supplier entity name matching at least one authenticated supplier entity name of the user database; categorize the at least one supplier entity name based on the associated category for the matched authenticated supplier entity name of the user database; and determine, based on the associated category, a normalized supplier entity name. In some embodiments, and in the instance where the at least one supplier entity name does not match an authenticated supplier entity name, the at least one processing device may further be configured to: submit the at least one supplier entity name to a search engine via an application programing interface to generate a search result; download the search result from the application programming interface; apply a natural language processor to the search result to generate at least one keyword from the search result; determine, based on the at least one keyword from the search result, a category associated with the at least one keyword, wherein the category is associated with a plurality of keywords including the at least one keyword; and determine, based on the category associated with the supplier entity name, the normalized supplier entity name.

In some embodiments, the source entity suggestion model comprises a bayes theorem.

In some embodiments, and wherein the source entity suggestion model is a machine learning model, the processing device is further configured to: collect a plurality of previously tagged variables, wherein the plurality of previously tagged variables comprises at least one of a positive feedback or a negative feedback; generate, based on the collected plurality of previously tagged variables, a previously tagged variable training dataset; and apply the previously tagged variable training dataset to the source entity suggestion model to train the source entity suggestion model.

In some embodiments, the at least one processing device is further configured to categorize the at least one normalized supplier entity name as a medical device manufacturer or a medical equipment manufacturer.

In some embodiments, the resource line item comprises data of at least one of a supplier's name, a service type of a supplier of the supplier entity name, an amount owed to the supplier, a due date of payment to the supplier, at least one payment term, or a balance due to the supplier.

In some embodiments, the entity name master record comprises a plurality of authenticated supplier entity names and at least one category for each authenticated supplier entity name, and wherein the normalized supplier entity name is matched to at least one authenticated supplier entity name. In some embodiments, the plurality of authenticated supplier entity names comprises a plurality of entity types for each authenticated supplier entity name.

In some embodiments, the processing device may further be configured to: receive a user identifier and at least one electronic record associated with the user; receive at least one source entity response from at least one source entity; update a predictive plan database with the at least one electronic record, wherein the predictive plan database comprises a plurality of electronic records associated with a plurality of recipients and a plurality of source entities; determine a previous transaction amount for each of the plurality of electronic records, wherein the previous transaction amount is based on at least one previous pre-determined variable standard for each source entity; and determine, based on the previous pre-determined variable standard and the previous transaction amount associated with each source entity of the plurality of source entities, at least one suggested source entity name which complies with the pre-determined variable standard and the transaction amount.

In some embodiments, each authenticated supplier entity name comprises an integer-based supplier name identifier.

In some embodiments, the processing device is further configured to: store, by an electronic record management module, a plurality of electronic records associated with each source entity of the plurality of authenticated source entity names, wherein the plurality of electronic records comprise data associated with each resource transaction.

In some embodiments, the variable data comprises data associated with at least one of a location, a service level, a service type, a transaction amount, a service term, a special amount discount, or a potential risk.

In some embodiments, the generation of the at least one normalized supplier entity name is generated by the processing device being further configured to: apply the at least one supplier entity name to a categorization machine learning model and at least one resource line item; and output, by the categorization machine learning model, the normalized supplier entity name and an associated category of the normalized supplier entity name. In some embodiments, the processing device is further configured to: collect a plurality of categorization variables associated with a plurality of supplier entity names, wherein the categorization variables comprise at least one of a general ledger code, a transaction date, a source organization, a source process center, or a source facilities type; generate a categorization training dataset, wherein the categorization training dataset comprises the plurality of categorization variables; and apply the categorization training dataset to the categorization machine learning model to train the categorization machine learning model.

In some embodiments, the processing device is further configured to: providing, by an entity terminal module, user data associated with at least one authenticated supplier entity name, wherein the user data comprises at least a username and at least one user record, and wherein the at least one user record comprises at least one completed resource transfer or service transfer between the username and an authenticated service entity name.

In another aspect, a computer program product for using machine learning to categorize and select suggested source entities is provided. In some embodiments, the computer program product comprises at least one non-transitory computer-readable medium having computer-readable program code portions embodied therein, the computer-readable program code portions which when executed by a processing device are configured to cause the processor to: receive a resource file from a user, the resource file comprising at least one supplier entity name and at least one resource line item; sort at least one resource line item in the resource file based on the at least one supplier entity name; normalize the at least one supplier entity name to generate at least one normalized supplier entity name; determine the at least one normalized supplier entity name matches an authenticated supplier entity name of an entity name master record; update, based on the normalized supplier entity name, a source entity management database, wherein the source entity management database comprises a plurality of authenticated supplier entity names and a plurality of previous variable data for each of the authenticated supplier entity names and at least one updated variable data for the normalized supplier entity name; receive a user indication, wherein the user indication comprises at least one pre-determined variable standard and a selected category; apply the at least one pre-determined variable standard and the selected category to a source entity suggestion model to output at least one suggested source entity name that matches the pre-determined variable standard and the selected category; and generate, based on the at least one suggested source entity name, a suggested source entity interface component to configure a graphical user interface of a user device associated with the user.

In another aspect, a computer-implemented method for using machine learning to categorize and select suggested source entities is provided. In some embodiments, the computer-implemented method comprises: receiving a resource file from a user, the resource file comprising at least one supplier entity name and at least one resource line item; sorting at least one resource line item in the resource file based on the at least one supplier entity name; normalizing the at least one supplier entity name to generate at least one normalized supplier entity name; determining the at least one normalized supplier entity name matches an authenticated supplier entity name of an entity name master record; updating, based on the normalized supplier entity name, a source entity management database, wherein the source entity management database comprises a plurality of authenticated supplier entity names and a plurality of previous variable data for each of the authenticated supplier entity names and at least one updated variable data for the normalized supplier entity name; receiving a user indication, wherein the user indication comprises at least one pre-determined variable standard and a selected category; applying the at least one pre-determined variable standard and the selected category to a source entity suggestion model to output at least one suggested source entity name that matches the pre-determined variable standard and the selected category; and generating, based on the at least one suggested source entity name, a suggested source entity interface component to configure a graphical user interface of a user device associated with the user.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a sub-combination or variation of a sub-combination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates a processing system environment designed for using machine learning to categorize and select suggested source entities, in accordance with an embodiment of the invention;

FIG. 2 illustrates a schematic representation of exemplary system components for managing supplier entities for recipient entities, and evaluating data associated with supplier entities to determine supplier entities for recipient entities, in accordance with an embodiment of the invention;

FIG. 3 illustrates an exemplary process flow for using machine learning to categorize and select suggested source entities, in accordance with an embodiment of the invention;

FIG. 4 illustrates an exemplary process flow for applying an agreement engine to the at least one resource agreement, in accordance with an embodiment of the invention;

FIG. 5 illustrates an exemplary process flow for determining the normalized supplier entity name in the instance where the supplier entity name does not match an authenticated supplier entity name, in accordance with an embodiment of the invention;

FIG. 6 illustrates an exemplary process flow for training a source entity suggestion model, in accordance with an embodiment of the invention;

FIG. 7 illustrates an exemplary process flow for training and using a categorization machine learning model, in accordance with an embodiment of the invention; and

FIG. 8 illustrates an exemplary graphical interface of the various category types for a category file, in accordance with an embodiment of the invention.

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In some embodiments, an “entity” “supplier entity,” or “source entity” as used herein may be any institution associated with providing resources, such as products and/or services. In some embodiments, the “entity” or “supplier entity” is a supplier associated with providing medical resources such as medical devices, medical equipment, and/or the like. That said, the entity or supplier entity may be any institution, group, association, establishment, company, union, manufacturer, supplier, and/or the like. Each supplier entity may be associated with supplier entity identifiers, such as supplier entity names.

In some embodiments, a “user” or “recipient” as used herein may be any individual or institution associated with receiving resources from the supplier entity, e.g., via a resource transfer therebetween. In some embodiments, the “user” is also referred to as a customer of the supplier entity (e.g., a supplier).

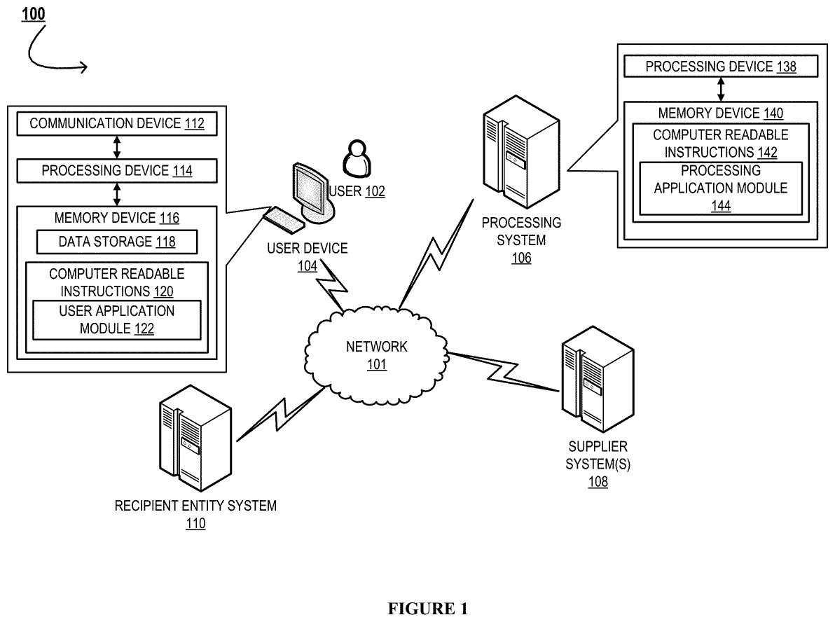

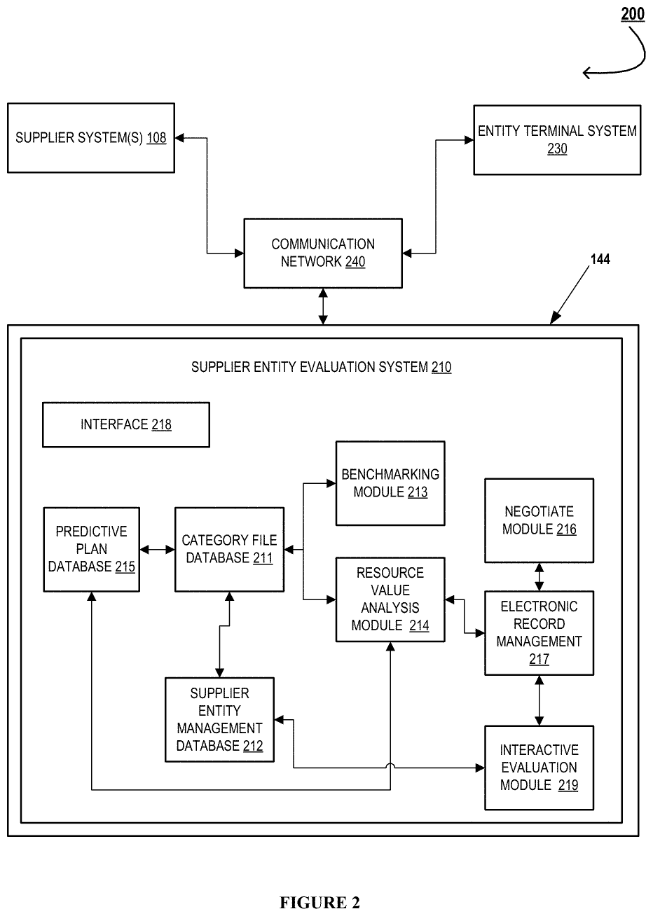

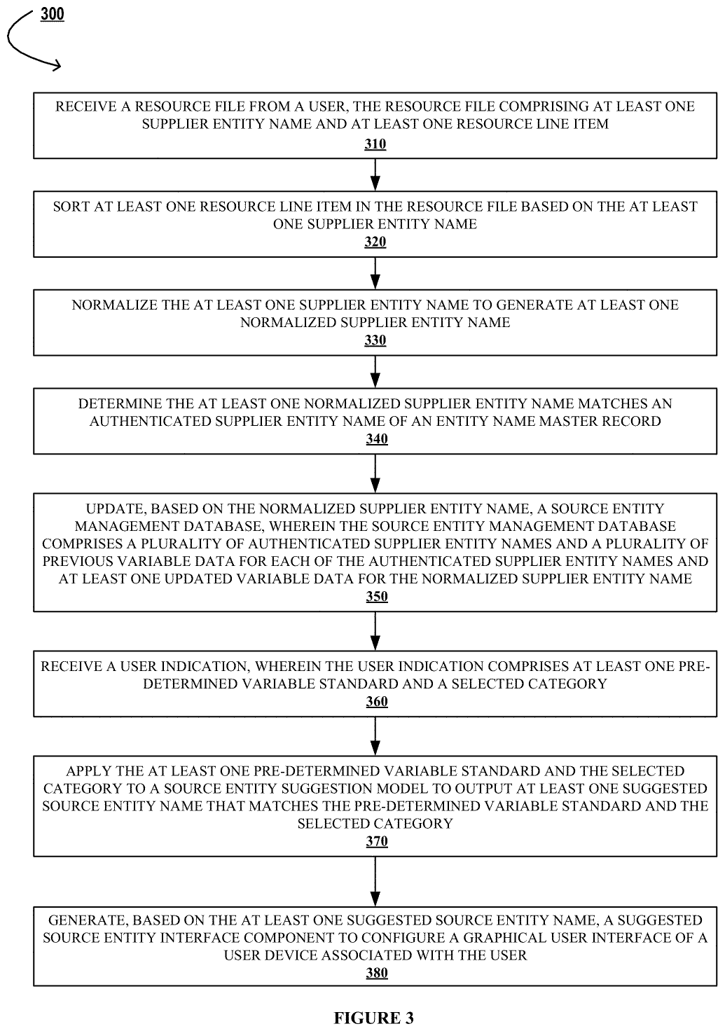

FIG. 1 illustrates a processing system environment 100 designed for using machine learning to categorize and select suggested source entities, in accordance with one embodiment of the invention. As illustrated in FIG. 1, a processing system 106 is operatively coupled, via a network 101 to a user system/device 104 associated with a user 102, a plurality of supplier systems 108 (also referred to as a source entity system(s) 108 or supplier entity system(s) 108) associated with the source/supplier entities, and/or a recipient entity system 110 (also referred to as a buyer system 110) associated with the recipient/buyer entity such as a healthcare organization. The processing system 106 may also be referred to as a “computing system”, “computing device,” “server” or “system”. The processing system 106 typically comprises at least one processing device 138 that is structured to perform one or more of the steps/functions associated with managing source entities for recipient entities, and evaluating data associated with source entities to determine resource providers for recipient entities (e.g., as described below with respect to FIGS. 2-3). Typically, the at least one processing device 138 is structured to perform one or more of the steps/functions described herein based on executing computer readable instructions/code 142 of a processing application module 144 stored on a memory device 140. The processing system 106 may be in operative communication with and may transmit signals to and receive signals from, the user device 104, the recipient entity system 110 and/or the supplier system 108 associated with the supplier entity. The processing system 106, and the processing application module 144 in particular, is structured for processing resource transfers/resource transactions and constructing resource values, e.g., based on executing computer-readable instructions 142. Specifically, the processing system 106, and the processing application module 144 in particular is structured for processing resource transfers by analyzing purchased services, and more particularly constructing resource values by predicting the prices of the transactions based on the input of the user. FIG. 1 illustrates only one example of an embodiment of the system environment 100, and it will be appreciated that in other embodiments one or more of the systems, devices, or servers may be combined into a single system, device, or server, or be made up of multiple systems, devices, or servers.

The network 101 may be a global area network (GAN), such as the Internet, a wide area network (WAN), a local area network (LAN), near field communication network, audio/radio communication network, ultra-high frequency wireless communication network, or any other type of network or combination of networks. The network 101 may provide for wireline, wireless, or a combination wireline and wireless communication between devices on the network 101.

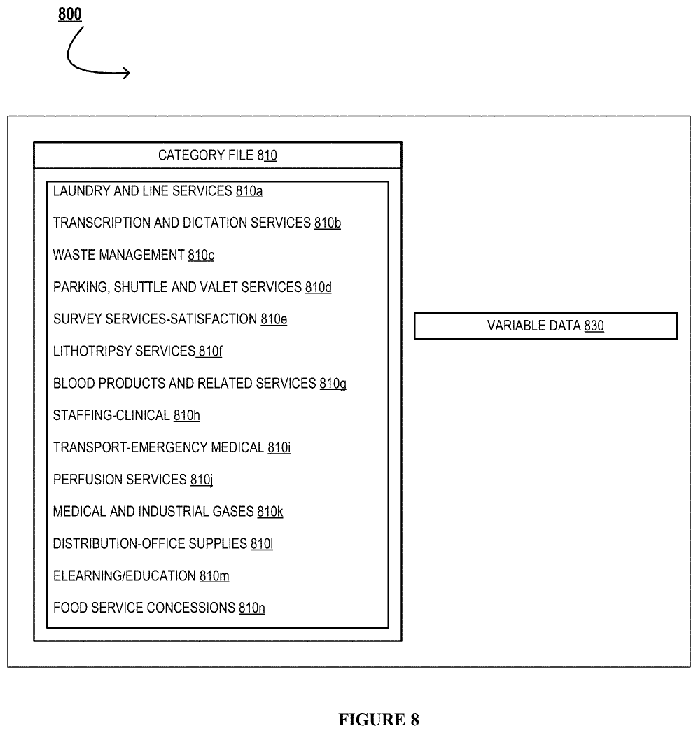

The user device 104 may comprise a communication device 112, a processing device 114, and a memory device 116. The memory device 116 may comprise a data storage 118, along with computer readable instructions 120 for a user application 122. The processing system 106 may transmit control signals/instructions to the user device 104, via the network 101, to cause the user application 122 to display a resource interface (e.g., the interface illustrated in FIG. 8) on a display device/component of the user device 104.

FIG. 2 illustrates a schematic representation 200 of system components for managing supplier entities for recipient entities, and evaluating data associated with supplier entities to determine supplier entities for recipient entities (e.g., managing suppliers for healthcare organization, in accordance with one embodiment of the invention). Specifically, FIG. 2 generally depicts a computer system and its components associated with the processing application module 144 of the processing system 106, which is structured for managing supplier entities for recipient entities, and evaluating data associated with supplier entities to determine supplier entities for recipient entities in accordance with one of the disclosed embodiments. The processing application module 144 may also be referred to as a computer-executable platform.

As illustrated by FIG. 2, the processing application module 144 may, in some embodiments, comprise a supplier entity evaluation system 210 (also referred to as a source entity evaluation system 210) communicating with the plurality of supplier systems 108 (also referred to as a supplier entity system(s) 108) and an entity terminal system 230 (also referred to as a business terminal system 230) via a communication network 240. In some embodiments, the communication network 240 is a part of the network 101 of FIG. 1.

Typically, and in some embodiments, the supplier entity evaluation system 210 (or source evaluation system 210) comprises a category file database 211 storing a plurality of category files and category types, and a supplier entity management database 212 (also referred to as a source management database 212) storing supplier entity data such as a plurality of variables associated with the supplier entities (source entities), a category associated with each supplier entity, at least one keyword associated with each supplier entity, and/or the like. The supplier entity evaluation system 210 (supplier evaluation system 210) further comprises a benchmarking module 213 structured for storing a plurality of source entity/supplier variables and variable standards (such as pre-determined variable standards), and a resource value analysis module 214 (cost analysis module 214) configured to generate transaction amount values corresponding to the supplier entities (source entities) and associated resource transactions.

As described previously, the benchmarking module 213 may comprise a plurality of source entity/supplier variables and variable standards provided by the source entity/supplier system(s) 108 and the entity/business terminal system 230. Here, not only the supplier entities, but also the users of the recipient entity systems 110 (e.g., healthcare organization and other such recipients of the products or services offered by the supplier entities) may update the source entity/supplier variable standards (e.g., pre-determined variable standards). The source entity (supplier) variable standards may comprise estimated costs, service level, and degrees of satisfaction of the service.

In one embodiment, the transaction amounts are calculated by the amount of expenses from each of the supplier entities. The resource value/cost analysis module 214 may calculate the transaction amounts and evaluate them in accordance with the source entity/supplier variable standards to generate the total transaction amounts.

As shown further in FIG. 2, the supplier entity evaluation system 210 (source evaluation system 210) further comprises a predictive plan database 215 structured to store a plurality of customer's electronic records (e.g., resource agreements) provided by the entity terminal systems 230 (business terminal systems 230). Here, the entity terminal system 230 (business terminal system 230) is an organization system based upon the healthcare organization and/or other such recipient entities. For example, the healthcare organization may be selected from a group consisting of hospitals, emergency centers, private clinics, and rehabilitation facilities. In other words, the business's users of the entity terminal system 230 (business terminal systems 230) can set up an account and upload their business' electronic records (resource agreements) to the supplier entity evaluation system 210 (source evaluation system 210) via the predictive plan database 215. Alternatively, the users may log into their accounts and update the latest changes in their current selected electronic records (resource agreements).

The present invention also features a negotiate module 216 structured for communicating with the plurality of supplier systems 108 (source entity system(s) 108) and the entity/business terminal system 230 through the communication network 240. Here, the negotiate module 216 may receive supplier entity/source entity responses in response to category files provided by the plurality of supplier systems 108 (source entity system(s) 108). In addition, the users from the entity/business terminal system 230 can negotiate the resource values or costs of the resources (products/services) in their electronic records/resource agreements via the negotiate module 216. Here, the negotiate module 216 may be designed as a real-time communication platform which allows the source entities/suppliers and the users to directly and operatively communicate thereon. In some embodiments, in response to the communication, the communications in the negotiate module 216 are written as an objective format. In this way, the source entity/supplier may directly update the quotations of their services, and the users from the business terminal system 230 may select a response “yes’ or “no” for their source/supplier entities' quotations. Alternatively, the users from the entity/business terminal system 730 may provide a transaction amount value for the source/supplier entity's services to the source entities/suppliers. If the source entity/supplier answers “yes” for that transaction amount value, the electronic record/contract management module 217 may automatically update the electronic records/resource agreements from the users in accordance with the transaction amount value. However, if the source entity (supplier) answers “no” for that transaction amount value, the communication may restart. Therefore, the communication in the negotiate module 216 may repeat again and again until the source entities (suppliers) and the users have the agreement about the services' contracts.

In another embodiment, the source entity evaluation system 210 (i.e., supplier evaluation system 210) further comprises an interface 218 enabling remote access through the communication network 240. The interface 218 enables the supplier entities (source entities) to electronically download the electronic records/resource agreements, which may be in the form of executable code or a protected data file. The interface 218 may allow the supplier entities to electronically upload the supplier's responses to the source entity evaluation system 210 (supplier evaluation system 210). In addition, the interface 218 may allow the supplier entities to selectively access the supplier entity management database 212 (source entity management database 212) in order to receive the information of existing vendor performance reports and product updates, as well as download the specifications relevant to the particular resource agreements.

The present system also features a benchmarking module 213 having a plurality of source entity/supplier entity variable standards provided by the source entity/supplier system(s) 108 and the entity/business terminal system 230. Here, not only the supplier entities, but also the users of the recipient entity systems 110 (e.g., healthcare organization) may update the source entity/supplier quality standards (e.g., pre-determined variable standards). The supplier entity variable standards may comprise estimated costs, service level, and degrees of satisfaction of the service. In one embodiment, the transaction amount values are calculated by the amount of expenses from each of the supplier entities. The resource value/cost analysis module 214 may calculate the transaction amount values and evaluate them in accordance with the source entity/supplier variable standards to generate the total transaction amount values.

In yet another embodiment, as shown further in FIG. 2, the supplier entity evaluation system 210 (supplier evaluation system 210) further comprises an interactive evaluation module 219 structured to determine a compliance supplier associated with the maturity customer's resource agreements in accordance with the pre-determined variable standards.

FIG. 3 illustrates an exemplary process flow 300 for using machine learning to categorize and select suggested source entities, in accordance with an embodiment of the invention. As described previously, some or all of the steps of process flow 300 may be performed by the system 106 (“the system”) in conjunction with the processing application module 144, via the network 140, as described with respect to FIG. 2. In some embodiments, and as described above, the process flow 300 may be performed by the system 106 in conjunction with source entity evaluation system 210, in conjunction with supplier system 106, communication network 240 (or network 140), and/or entity terminal system 230, as shown in FIG. 2.

As shown in block 310, the process flow 300 may include the step of receiving a resource file from a user, the resource file comprising at least one supplier entity name and at least one resource line item. In some embodiments, the system may receive a resource file from a user, such as a user associated with the system like a user associated with a client of the system (e.g., a client using the system to determine suggested supplier entities to use in a particular instance or throughout their day-to-day business), a manager of the system, and/or the like.

In some embodiments, the resource file may comprise at least one supplier entity name and at least one resource line item from each supplier entity name. For instance, the resource file may comprise a ledger or record of at least one resource transaction between a supplier entity/source entity (e.g., supplier entity name) and a user or recipient entity (e.g., a buyer of the resource for the resource transaction), where each resource of each recorded resource transaction is indicated as a resource line item within the resource file. As used herein, a resource transaction may refer to a transaction of products, services, and/or the like between a supplier entity (or source entity) to a recipient (i.e., recipient entity or buyer entity), and each resource line item in the resource file may comprise data (e.g., name of the product or service, identifier of the product or service unique to the supplier entity, product code, transaction date, location, and/or the like) which identifies the product or service given to the recipient.

In some embodiments, the system may receive a resource file that comprises all of the resource transactions between a single supplier entity and a single recipient. By way of non-limiting example, the resource file may comprise all the resource line items for all the resource transactions between the single supplier entity and the single recipient from the beginning of the supplier-recipient relationship, from a predetermined period, and/or the like.

In some embodiments, the system may receive a resource file comprising all of the resource transactions received for a single recipient (e.g., a single user), even from a plurality of supplier entities. By way of non-limiting example, the system may receive the resource file that comprises all the resource line items received (e.g., completed resource transactions) for the single recipient, from a plurality of supplier entities, over a predetermined period, over all the time the recipient has been in business, and/or the like

In some embodiments, the resource file may comprise all the resource transactions between all the supplier entities known to the system and all the users (e.g., recipients) associated with the system, such that the resource file is an overall record of all the resource transactions recorded and/or completed. For instance, the resource file may comprise all the resource line items of the resources received by all the recipients associated with the system from all the supplier entities of each resource line item. In some embodiments, and where the resource file comprises all the resource transactions between all the known supplier entities and known recipients, the resource file may be organized based on a predetermined time period, such that only those resource transactions within the predetermined time period are collected in the resource file. Such a predetermined time period may predetermined by a manager of the system, by a client of the system, and/or the like.

As shown in block 320, the process flow 300 may include the step of sorting at least one resource line item in the resource file based on the at least one supplier entity name. In some embodiments, the system may sort (or group) each of the resource line items of the resource file based on each supplier entity's name. For instance, and where the resource file comprises a plurality of supplier entity names associated with a plurality of resource line items (e.g., resource transactions), the system may sort each of the resource line items to cluster all of the resource line items associated with each same supplier entity name, such that the resource line items are clustered together for each supplier entity name. In some embodiments, such a sorting of the resource line items associated with each supplier entity name may be organized alphabetically, by supplier entity name. In some embodiments, the system itself (e.g., a database such as a supplier entity management database, storage, memory, and/or the like, of the system) may sort and store the resource line items which have been clustered by the supplier entity name(s).

In some embodiments, each resource line item may comprise data of at least one of a supplier's name (supplier entity name), a service type of a supplier of the supplier entity name (e.g., medical device manufacturer; medical equipment manufacture; a laundry and line services; transcription service; waste management, parking, shuttle, and valet services; survey services satisfaction; and/or the like), an amount owed to the supplier (e.g., an amount of money owed to the supplier entity), a due date of payment to the supplier, at least one payment term (e.g., a brief description of each resource within each resource transaction, a price per unit and/or per service, date of resource transaction/services rendered, late fee terms, and/or the like), and/or a balance due to the supplier (e.g., a current total balance due to the supplier entity from a recipient and/or a plurality of recipients).

As shown in block 330, the process flow 300 may include the step of normalizing the at least one supplier entity name to generate at least one normalized supplier entity name. In some embodiments, the system may normalize each supplier entity name of the resource file where the supplier entity name of the resource file does not match an authenticated supplier entity name of an entity name master record. For instance, and where a supplier entity name of a resource file comprises a name such as “DEF Corp.,” but where a similar supplier entity name is found in the entity name master record as “DEF, Corp.” as an authenticated supplier entity name, the system may normalize the supplier entity name of the resource file to match the authenticated supplier entity name.

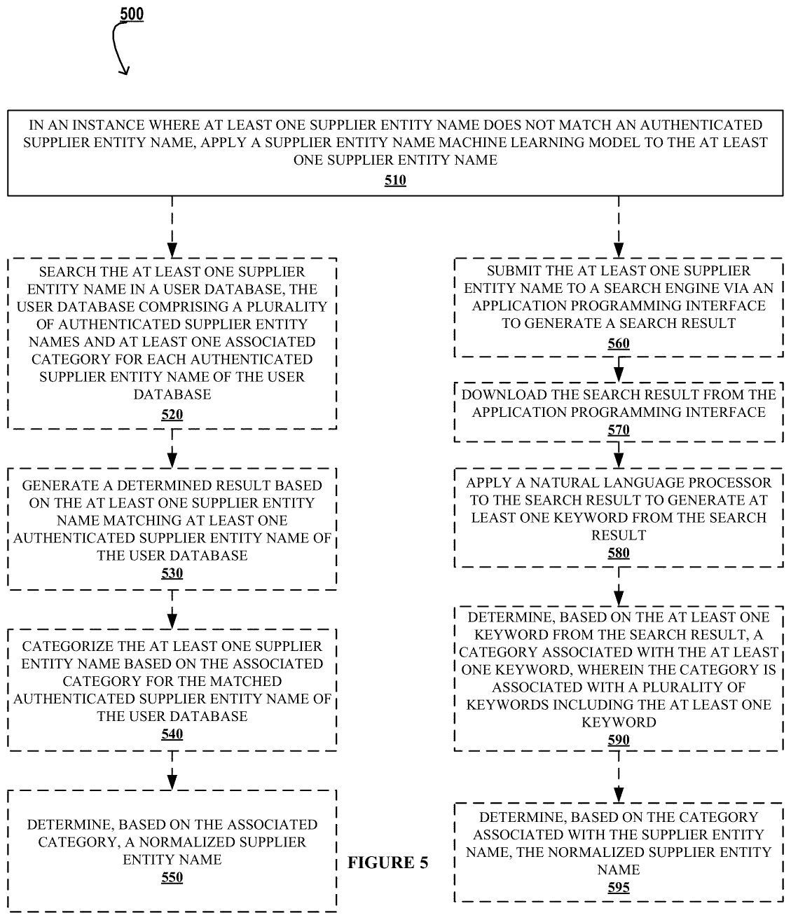

In some embodiments, and where the system cannot determine, based alone on the supplier entity name of the resource file and the authenticated supplier entity name, the normalized supplier entity name, then the system may apply a supplier entity name machine learning model to determine the normalized supplier entity name (e.g., where the supplier entity name comprises “DEF Corp.,” and the similar authenticated supplier entity name in the entity name master record comprises “DEF Inc.”; and/or where the supplier entity name comprises “DEFG Corp,” and the most-similar authenticated supplier entity name in the entity name master record comprises, “DEF Inc.”). Such a process using the suppler entity name machine learning model to generate the normalized supplier entity name is discussed in further detail below with respect to FIG. 5.

As shown in block 340, the process flow 300 may include the step of determining the at least one normalized supplier entity name matches an authenticated supplier entity name of an entity name master record. In some embodiments, the system may determine the normalized supplier name for each of the supplier entity names of the resource file by matching the normalized supplier entity name to an authenticated supplier entity name of the entity name master record. Such an entity name master record may comprise previously authenticated supplier entity names of previous resource transactions identified by the system, where the previously authenticated supplier entity names are those supplier entity names that have been authenticated by the system itself, by the supplier entity itself, by a recipient, and/or the like.

In some embodiments, the entity name master record may comprise a plurality of authenticated supplier entity names and at least one category for each authenticated supplier entity name, such that the entity name master record may comprise at least one category of resources (e.g., products and/or service types) that each supplier entity practices in (e.g., transacts in and/or sells). In some embodiments, the normalized supplier entity name may be matched to at least one authenticated supplier entity name, which may additionally allow the normalized supplier entity name to further be matched to the associated category(ies) of the authenticated supplier entity name of the entity name master record. For instance, and in some embodiments, the system may categorize the at least one normalized supplier entity name as a medical device manufacturer or a medical equipment manufacturer.

Further and in some embodiments, the system may determine each entity type (e.g., a Limited Liability Corporation (LLC), a Corporation, Incorporated, Inc., and/or the like) for each authenticated supplier entity name, where each entity type is comprised within the authenticated supplier entity name. Similar to the example provided above, a supplier entity name of the resource file may comprise a different entity type (e.g., “DEF Corp.”) in its supplier entity name than the entity type comprised within the authenticated supplier name of the entity name master record (e.g., “DEF Inc.”), then the system may determine on its own that the supplier entity name of the resource file should be normalized (e.g., changed to “DEF Inc.”) to match the authenticated supplier entity name, or the system may apply the supplier entity name of the resource file to the supplier entity name machine learning model to determine the normalized supplier entity name. Such a rule as when to apply the supplier entity name machine learning model may be determined by a manager of the system, a client of the system, and/or the like.

In some embodiments and based on each authenticated supplier entity name within the entity name master record, each authenticated supplier entity name may comprise an integer-based supplier name identifier which may uniquely identify each authenticated supplier entity name associated with the system. For instance, and as used herein, the integer-based supplier name identifier may comprise a unique string of alphanumeric characters, a unique string of numbers, and/or the like, which may be unique for each associated authenticated supplier entity name within the entity name master record. In some embodiments, and as new authenticated supplier entity names are added to the entity name master record (i.e., each time the entity name master record is updated), the system may generate a new, unique supplier name identifier for each new authenticated supplier entity name.

As shown in block 350, the process flow 300 may include the step of updating, based on the normalized supplier entity name, a supplier entity management database, wherein the supplier entity management database comprises a plurality of authenticated supplier entity names and a plurality of previous variable data for each of the authenticated supplier entity names and at least one updated variable data for the normalized supplier entity name. In some embodiments, the system may update a supplier entity management database, which may comprise all the data associated with each normalized or authenticated supplier entity name determined by the system, each resource transaction identified by the system, each resource line item associated with each resource transaction, each recipient of each resource transaction identified by the system, and/or the like.

In some embodiments, the system may additionally track variable data associated with each resource transaction, where such variable data may comprise data of a location of the resource transaction (e.g., a location of services rendered, a location of product shipment, a final location of product shipment, a location of product generation/creation, a location of services generated or rendered, and/or the like); data associated with a service level (e.g., whether the services rendered met expectations, were unsatisfactory, were exceptional, exceeded expectations, and/or the like); data associated with a transaction amount (e.g., the agreed-upon transaction payment, the price per unit/service unit, the agreed-upon late fee payment, and/or the like); data associated with a service team (e.g., whether a service team is local or abroad, and/or the like); data associated with a special amount discount (e.g., whether a specific amount of the agreed-upon payment should be discounted and/or the like); data associated with a potential risk (e.g., whether previous resource transactions by the same supplier entity have been unmet or late, whether a supply chain shortage is likely to occur, whether previous resource transactions by the supplier entity have not met expectations, and/or the like) and/or the like. In some embodiments, the variable data of each resource transaction may comprise only one type of variable data, a combination of types of variable data, all the types of variable data, and/or the like.

In some embodiments, the system may collect all the previous variable data for each of the previously completed resource transactions that the system has identified and received resource files for. In this manner, the system may collect all the variable data for each of the authenticated supplier entity names from previous resource transactions, and may also collect all the newly received and/or newly identified variable data from the currently received or identified resource transactions, including the new variable data (e.g., updated variable data) for the normalized supplier name, where the normalized supplier name is associated with the supplier entity name of the recently received resource file. Thus, and in some embodiments, the system may update the source entity management database continuously with all the received and identified resource transactions and associated data (e.g., previous variable data and updated variable data) associated with the supplier entity names (e.g., authenticated and/or normalized supplier entity names of the source entity management database).

As shown in block 360, the process flow 300 may include the step of receiving a user indication, wherein the user indication comprises at least one pre-determined variable standard and a selected category. In some embodiments, the system may receive a user indication which may indicate a user (or recipient) preference for a supplier entity. For instance, the user indication may be received from a user device (e.g., such as user device 104 in communication with processing system 106 over network 101), where the user indication may comprise at least one preference or standard for which a potential supplier entity should abide by in completing a requested resource transaction (e.g., requested by the user/recipient). In this manner, the user indication may comprise at least one pre-determined variable standard, which indicates a particular variable (e.g., location of the resource transaction, a service level of the resource transaction, a transaction amount of the resource transaction, a service team for the resource transaction, a special amount discount of the resource transaction, a potential risk that the resource transaction should avoid, and/or the like). Further, and in some embodiments, the user indication may comprise a selected category of the type of resource for the resource transaction (e.g., a type of service or product, such as but not limited to laundry and line services; transcription and dictation services; waste management; parking, shuttle and valet services; survey services-satisfaction; medical device manufacturer; medical device equipment manufacturer; lithotripsy services; blood products and related services; staffing-clinical; transport-emergency medical; perfusion services; medical and industrial gases; distribution-office supplies; e-learning/education; food service concessions; and/or the like), whereby the selected category may be pre-selected by the user and the user indication may be transmitted to the processing system 106 via the network 101.

As shown in block 370, the process flow 300 may include the step of applying the at least one pre-determined variable standard and the selected category to a source entity suggestion model to output at least one suggested source entity name that matches the pre-determined variable standard(s) and the selected category. In some embodiments, the system may apply the at least one pre-determined variable standard and the selected category (from the user or potential recipient), to a source entity suggestion model, which may in-turn output or generate at least one suggested source entity name that matches the specifications outlined by the user (e.g., matches the pre-determined variable standard(s) and the selected category).

Such a source entity suggestion model may consider each of the variables (e.g., previous variables and updated variables) of each of the authenticated supplier entity names and the associated category(ies) for each of the authenticated supplier entities, in order to determine the best potential supplier entity for the potential resource transaction. For example, the source entity suggestion model may use the at least one pre-determined variable standard (or multiple pre-determined variable standards) and selected category to sort which authenticated supplier entities to choose from in determining at least one suggested source entity to present to the user/potential recipient to choose from in completing a resource transaction. In this manner, the system may narrow down the potential supplier entities to present to the user/potential recipient based on the at least one pre-determined variable standard (e.g., the standard that the user has required or requested for at least one variable) and the selected category in an efficient, accurate, and broad manner by considering all of the authenticated supplier entity names and their associated variable data automatically upon receiving the resource file from the user.

Once the potential supplier entities have been narrowed down, the source entity suggestion model may determine, based on previous training, which variables belonging to the associated narrowed down list of supplier entities are best (e.g., the location closest to the user may be the best as compared to a supplier entity located hundreds of miles away, a supplier entity having a higher service level may be preferred over a lower service level, the supplier entity having a lower transaction amount may be preferred over a supplier entity having a higher transaction amount, a particular service team associated with a supplier entity may be preferred over a different service team associated with a different supplier entity, a supplier entity having a larger special amount discount may be preferred over a supplier entity having a smaller special amount discount, a potential risk of one supplier entity may be preferred over a different potential risk of another supplier entity, and/or the like).

In some embodiments, each of the variables for each of the authenticated supplier entities may be considered to be of equal weight by the source entity suggestion model. In some embodiments, certain variables may be considered to have a higher weight than other variables when the source entity suggestion model is generating the suggested source entity name(s).

In some embodiments, the source entity suggestion model may comprise a bayes theorem or algorithm. In this manner, the source entity suggestion model may determine or output the suggested source entity name(s) despite one or more variables not being provided with respect to the associated authenticated source entity name(s). Similarly, and where the user does not provide a user indication comprising pre-determined variable standards for all the potential variables associated with the authenticated supplier entity names, then the source entity suggestion model (using the bayes theorem) may still determine which source entities to suggest despite the lack of knowledge regarding specific variable standards for at least one variable. Such a determination by the source entity suggestion model may consider which variables are most likely preferred by the user/potential recipient.

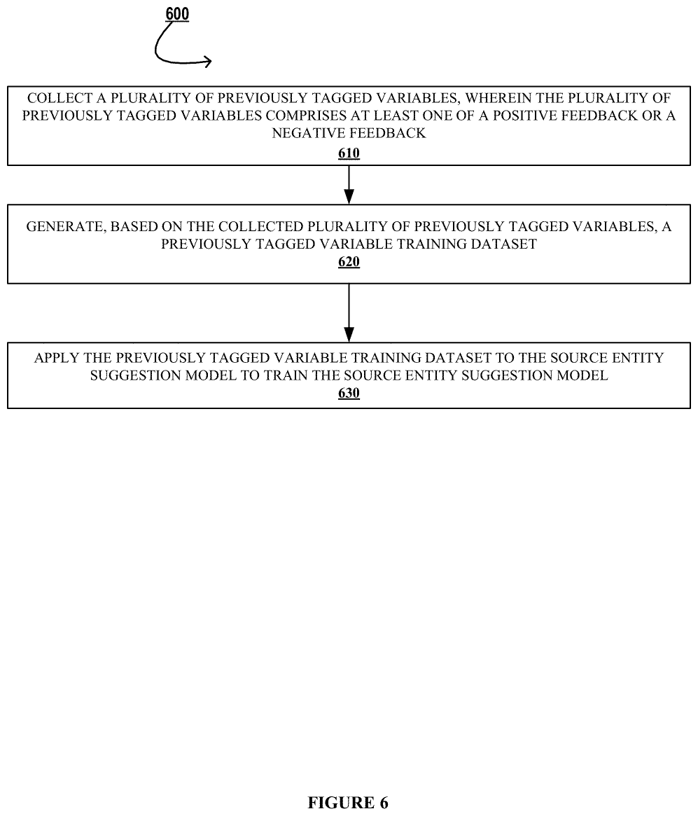

In some embodiments, the source entity suggestion model may be a machine learning model. The training of such a source entity suggestion model is described in further detail below with respect to FIG. 6.

As shown in block 380, the process flow 300 may include the step of generating, based on the at least one suggested source entity name, a suggested source entity interface component to configure a graphical user interface (GUI) of a user device associated with the user. In some embodiments, the system may generate, based on the at least one suggested source entity name(s) generated by the source entity suggestion model, a suggested source entity interface component to configure a GUI of the user device associated with the user/potential recipient that provided the pre-determined variable standard and the selected category. In this manner, the suggested source entity interface component may comprise data of the at least one suggested source entity name (or plurality of the suggested source entity names) which may be transmitted from the system 106, over a network (e.g., network 101), to the user device (e.g., user device 104) to show the suggested source entity name(s) to the user/potential recipient for selection.

In some embodiments, such a selection by the user/potential recipient of the at least one suggested source entity name(s) may comprise a user interaction with the user device during the suggested source entity name configured GUI. In this manner, the user/potential recipient may view the details and/or data associated with each suggested source entity name in order to make an informed decision on which suggested source entity to choose for a particular resource transaction.

In some embodiments, the system may further be configured to include the step of storing, by an electronic record management module (like the electronic record management module 217 shown in FIG. 2), a plurality of electronic records associated with each source entity of the plurality of authenticated source entity names, wherein the plurality of electronic records comprise data associated with each resource transaction (e.g., each resource transaction that was previously completed). In some embodiments, the system 106 may collect and store each piece of data associated with each resource transaction, which may further include at least the recipient data for each resource transaction, each supplier entity of each resource transaction, at least one variable, and/or the like. In this manner, the system may track all of the resource transactions identified by the system and keep such data in an up-to-date record.

For instance and in some embodiments, the system may further be configured to include the step of providing, by an entity terminal module, user data associated with at least one authenticated supplier entity name, wherein the user data comprises at least a username and at least one user record (e.g., a recipient name and at least one recipient record), and wherein the at least one user record comprises at least one completed resource transfer or service transfer between the username and an authenticated service entity name. In some embodiments, the system may track the completed resource transactions between users/recipients and supplier entities, such as by tracking each of the resource transactions conducted using entity terminals (e.g., terminal devices associated with resource transactions such as point of sale devices and/or the like) and/or downloadable entity terminal modules (e.g., software configured to be used with a plurality of devices, including user devices or mobile devices, where resource transactions may be completed).

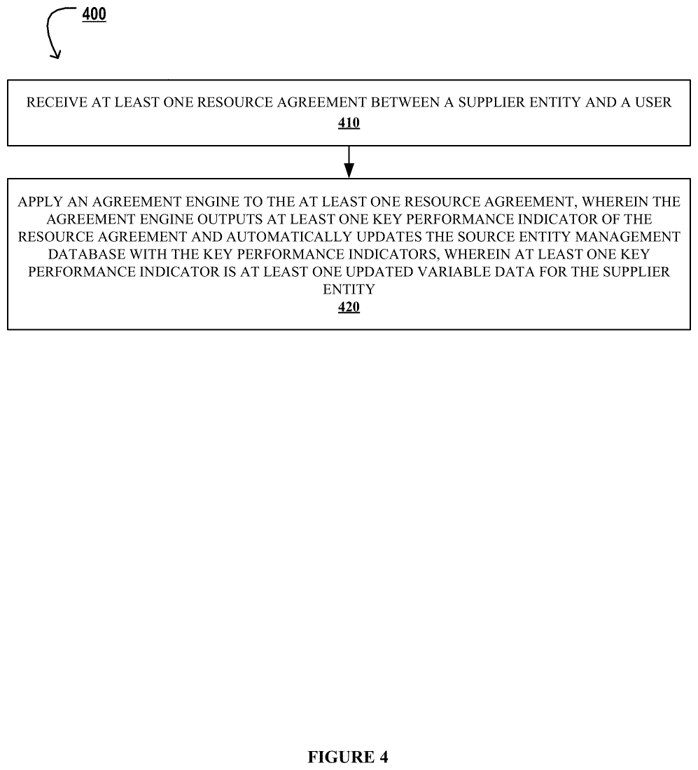

FIG. 4 illustrates an exemplary process flow 400 for applying an agreement engine to the at least one resource agreement, in accordance with an embodiment of the invention. As described previously, some or all of the steps of process flow 400 may be performed by the system 106 (“the system”) in conjunction with the processing application module 144, via the network 140, as described with respect to FIG. 2. In some embodiments, and as described above, the process flow 400 may be performed by the system 106 in conjunction with source entity evaluation system 210, in conjunction with supplier system 106, communication network 240 (or network 140), and/or entity terminal system 230, as shown in FIG. 2.

As shown in block 410, the process flow 400 may include the step of receiving at least one resource agreement between a supplier entity and a user. In some embodiments, the system 106 may receive at least one resource agreement (such as a resource agreement regarding a resource transaction) between a supplier entity and a user (a recipient). Such a resource agreement may comprise a plurality of variables and/or terms, which may include an identification of a location where the services are to be rendered or where the product is to be shipped, a payment amount for the services or product(s), an amount (e.g., unit amount and/or amount of manpower) for services or products, a time period for completion of the resource transaction (e.g., until products are received and/or until services have been rendered) and/or the like.

In some embodiments, the system may receive the at least one resource agreement and/or a plurality of resource agreements from a user device associated with the system, from a database associated with the system (e.g., such as a database associated with the electronic record management module, a source entity management database, and/or the like), and/or the like.

As shown in block 420, the process flow 400 may include the step of applying an agreement engine to the at least one resource agreement, wherein the agreement engine outputs at least one key performance indicator of the resource agreement and automatically updates the source entity management database with the key performance indicators, wherein at least one key performance indicator is at least one updated variable data for the supplier entity. In some embodiments, the system 106 may apply an agreement engine to the at least one resource agreement, where such an agreement engine may be configured to determine all the key performance indicators of the resource agreement. As used herein, the term key performance indicator may refer to key terms, clauses, and/or provisions within each resource agreement.

By way of non-limiting example, the agreement engine may be trained based on identifying previous key performance indicators or previous resource agreements, where such an agreement engine may comprise a feedback loop allowing for the continuous training of the agreement engine as it outputs key performance indicators of current resource agreements. In some embodiments, the agreement engine may be configured to accept a user indication—and/or a user indication from a user associated with the manager of the system—whether the key performance indicator determined by the agreement engine is in fact a key term, clause, and/or provision.

In some embodiments, the key performance indicators may be used in determining the previous variables and updated variables in the resource transactions. For instance, the key performance indicators of previous resource transactions and/or current resource transactions may be used to determine the variables (e.g., previous variables and updated variables), automatically, of the previous resource transactions and current resource transaction(s). By way of non-limiting example, the variables of the resource transactions may be identified by the key performance indicators identified by the agreement engine, such that the variable(s) are the key performance indicator(s).

FIG. 5 illustrates an exemplary process flow 500 for determining the normalized supplier entity name in the instance where the supplier entity name does not match an authenticated supplier entity name, in accordance with an embodiment of the invention. As described previously, some or all of the steps of process flow 500 may be performed by the system 106 (“the system”) in conjunction with the processing application module 144, via the network 140, as described with respect to FIG. 2. In some embodiments, and as described above, the process flow 500 may be performed by the system 106 in conjunction with source entity evaluation system 210, in conjunction with supplier system 106, communication network 240 (or network 140), and/or entity terminal system 230, as shown in FIG. 2.

As shown in block 510, the process flow 500 may include the step of applying, in an instance where at least one supplier entity name does not match an authenticated supplier entity name, a supplier entity name machine learning model to the at least one supplier entity name. In some embodiments, the system 106 may be unable to match a received supplier entity name (e.g., received from a resource file) with an authenticated supplier entity name or match a normalized version of the supplier entity name with an authenticated supplier entity name. For instance, and where the normalized version of the supplier entity name comprises adding a punctuation in order to match an authenticated supplier entity name (e.g., the supplier entity name may be “DEF Inc.,” the closest authenticated supplier entity name may be “DEF, Inc.,” and the normalized supplier entity name may then be “DEF, Inc.”), then the system 106 may need to complete at least one of the processes described in further detail below to generate the normalized supplier entity name.

In some embodiments, and as shown in block 520, the process flow 500 may include the step of searching the at least one supplier entity name in a user database, the user database comprising a plurality of authenticated supplier entity names and at least one associated category for each authenticated supplier entity name of the user database. In some embodiments, the system may search the at least one supplier entity name in a user database, where such a user database may comprise at least one authenticated supplier entity name that have been previously authenticated by the system and are associated with at least one other user. For instance, the user database may comprise all the authenticated supplier entity names for all the resource transactions for all the users/recipients identified by the system. In this manner, the system tracks all of the authenticated supplier entity names for all the resource transactions identified by the system, regardless of user or recipient.

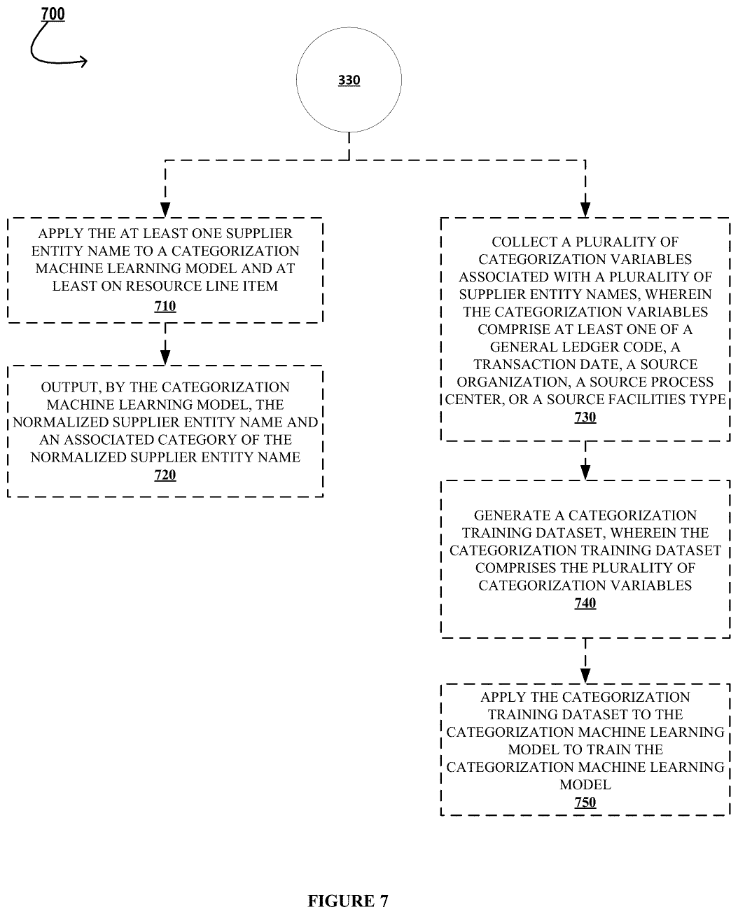

In some embodiments, the user database may further comprise each associated category for each authenticated supplier entity name, where each category may have been identified by the system itself (e.g., such as a categorization machine learning model which is described in more detail below with respect to FIG. 7) and/or by a user indicating what each authenticated supplier entity name's category should be. Such a categorization may comprise the type of product or service offered by the authenticated supplier entity.

In some embodiments, and as shown in block 530, the process flow 500 may include the step of generating a determined result based on the at least one supplier entity name matching at least one authenticated supplier entity name of the user database. In some embodiments, the system may generate a determined result based on the at least one supplier entity name matching at least one authenticated supplier entity name from the user database, where such a matching may comprise an exact matching (including spelling, punctuation, capitalization, entity type, and/or the like) or an almost-exact matching (e.g., including spelling, slightly different punctuation, slightly different entity type, slightly different capitalization, and/or the like). For instance, and where the supplier entity name comprises “DeF Inc.” and an authenticated supplier entity name of the user database comprises “DEF Inc.,” the system may determine the supplier entity name to almost-exact match the authenticated supplier entity name and may normalize the supplier entity name to match the authenticated supplier entity name. Additionally, and by way of non-limiting example, a supplier entity name may comprise “DEF, Corp.” and an authenticated supplier entity name may comprise “DEF, Inc.,” then the system may determine the supplier entity name to almost-exactly match the authenticated supplier entity name and may normalize the supplier entity name to match the authenticated supplier entity name. In some embodiments, the rule of what to allow as an almost-exact match between supplier entity name and authenticated supplier entity name (e.g., slightly different punctuation, slightly different entity type, and/or slightly different capitalization) may be pre-determined by the system itself, by a manager of the system, and/or the like.

In some embodiments, and as shown in block 540, the process flow 500 may include the step of categorizing the at least one supplier entity name based on the associated category for the matched authenticated supplier entity name of the user database. In some embodiments, the system may categorize the at least one supplier entity name based on the associated category of the matched authenticated supplier entity name, such that the category of the supplier entity name that has been determined to match (exact match and/or almost-exact match) will also match the category of the authenticated supplier entity name.

In some embodiments, and as shown in block 550, the process flow 500 may include the step of determining, based on the associated category, a normalized supplier entity name. By way of non-limiting example, and as described above, the system may normalize or generate a normalized supplier entity name of the supplier entity name by matching (e.g., exactly matching or almost-exactly matching) the supplier entity name with an authenticated supplier entity name of the user database. In this manner, the system 106 may update the supplier entity name to match a previously authenticated supplier entity name to better keep track of all the supplier entity names of all the resource transactions (e.g., by consolidating and storing all the data associated with each resource transaction under an authenticated or normalized supplier entity name, such that there are not multiple supplier entity names or multiple databases for the same supplier entity). In this manner, the normalized supplier entity names and the authenticated supplier entity names allow the system to consolidate all the potential supplier entity name variations to one normalized supplier entity name to keep track of each of the resource transactions and their associated data under a singular normalized supplier entity name rather than multiple, slightly different supplier entity names. Such a normalization tactic may then be used to improve processing speeds, storage capabilities, and/or the like of the system by allowing a one-step re-call of the resource transactions associated with a single supplier entity name rather than having to call up all of the resource transactions of a plurality of supplier entity names for a single supplier entity.

In some embodiments, and as shown in block 560, the process flow 500 may include the step of submitting the at least one supplier entity name to a search engine via an application programming interface to generate a search result. In some embodiments, the system may additionally, or alternatively, submit the at least one supplier entity name to a search engine to determine the normalized supplier entity name. For instance, the system may submit at least one supplier entity name that does not match an authenticated supplier entity name to a search engine via an application programming interface (API), and the API may then generate a search result based on the at least one supplier entity name, where the search result may comprise at least one web site comprising the supplier entity name and data regarding what the supplier entity does (e.g., products the supplier entity sells or services the supplier entity completes). In some embodiments, the system may generate a plurality of search results comprising a plurality of websites, hyperlinks, data, and/or the like, which may all comprise at least one instance of the supplier entity name and may further comprise data associated with the supplier entity name.

In some embodiments, and as shown in block 570, the process flow 500 may include the step of downloading the search result from the application programming interface. In some embodiments, the system 106 may download the search result(s) from the application programming interface such that the system may analyze, parse, dissect, and/or detect certain keywords or key phrases of the search result(s) in order to determine the normalized supplier entity name and/or a specific category of the supplier entity. In this manner, the system may download the search result(s) in order to fully parse the data of the search result(s).

In some embodiments, and as shown in block 580, the process flow 500 may include the step of applying a natural language processor to the search result(s) to generate at least one keyword from the search result(s). By way of non-limiting example, the system 106 may apply the natural language processor (NLP) to the search result(s) to determine specific keywords and/or key phrases that may be important in determining a category of the supplier entity name. For instance, such keywords determined and/or generated by the NLP may comprise keywords associated with a particular product, a particular service industry, and/or the like. For instance, and where a keyword generated by an NLP comprises a particular medical device product, the system may use the keyword to determine a category of the supplier entity name is a medical device manufacturer.

By way of non-limiting example, the NLP may scrape and/or analyze all the data within the at least one search result in order to generate at least one keyword (and/or a plurality of keywords) that are pertinent to determining a category of the supplier entity name.

In some embodiments, and as shown in block 590, the process flow 500 may include the step of determining, based on the at least one keyword from the search result, a category associated with the at least one keyword, wherein the category is associated with a plurality of keywords including the at least one keyword. In some embodiments, the system may determine a category for the supplier entity name by determining the at least one keyword generated by the NLP can be mapped or is associated with a category identified by the system. For instance, the system may store and/or comprise a plurality of categories from which a supplier entity may be associated with, where each category comprises or is associated with at least one keyword (e.g., each category may be mapped to at least one keyword which may be used to describe the category), and each keyword associated with each category may be compared with the keyword generated by the NLP. Thus, when a keyword is generated by the NLP from the at least one search result, the system may compare the generated keyword against a plurality of keywords stored and sorted (based on categories) within the system in order to determine at least one matching stored keyword, and based on such matching, the system may map the generated keyword to the associated category of the stored keyword in order to determine the category of the supplier entity name of the at least one search result.

In some embodiments, and where a plurality of keywords are generated by the NLP, each generated keyword by the NLP may be compared against the plurality of stored keywords in order to determine the category of the supplier entity name. In some embodiments, and where the plurality of keywords are generated and can be mapped to a plurality of keywords associated with a plurality of categories, then the system may determine the category for the supplier entity name should be the category comprising the most stored keywords that match the NLP-generated keywords. In this manner, the higher the number of stored keywords that match the NLP-generated the keywords, the more likely the associated category will be determined for the supplier entity name.

In some embodiments, and as shown in block 595, the process flow 500 may include the step of determining, based on the category associated with the supplier entity name, the normalized supplier entity name. By way of non-limiting example, the system may determine, based on the category determined by the system, a normalized supplier entity name of the received supplier entity name by mapping the determined category to a similar authenticated supplier entity name. For instance, and where a received supplier entity name comprises “DEF Corp.,” and has been mapped to a category such as a medical device manufacturer due to its determined keywords, the category of medical device manufacturer may comprise an authenticated supplier entity name of “DEFG Inc.” which comprises the same keywords and comprises the same category, then the system may determine the normalized supplier entity name is also “DEFG Inc.” for the received supplier entity name.

FIG. 6 illustrates an exemplary process flow 600 for training a source entity suggestion model, in accordance with an embodiment of the invention. As described previously, some or all of the steps of process flow 600 may be performed by the system 106 (“the system”) in conjunction with the processing application module 144, via the network 140, as described with respect to FIG. 2. In some embodiments, and as described above, the process flow 600 may be performed by the system 106 in conjunction with source entity evaluation system 210, in conjunction with supplier system 106, communication network 240 (or network 140), and/or entity terminal system 230, as shown in FIG. 2.

As shown in block 610, the process flow 600 may include the step of collecting a plurality of previously tagged variables, wherein each of the plurality of previously tagged variables comprises at least one of a positive feedback or a negative feedback. In some embodiments, the system 106 may collect a plurality of previously tagged variables, such as variables that have been previously tagged by humans and/or users of the system, where each tag may comprise at least one of a positive or negative feedback. As used herein, a positive feedback may indicate a variable is desired over other variables. Similarly, a negative feedback may indicate a variable is undesirable as compared to other variables. For instance, a variable comprising a lower transaction amount (e.g., a lower fee for the product or service) may be more desirable than a variable comprising a higher transaction amount (e.g., a higher fee for the product or service), and thus, the variable comprising the lower transaction amount may comprise positive feedback and the variable comprising the higher transaction amount may comprise negative feedback. Similarly, and in some embodiments, a variable comprising a location close to the recipient may comprise positive feedback and a variable comprising a location further away from the recipient may comprise negative feedback. Similarly, a variable comprising a higher service level may comprise positive feedback and a variable comprising a lower service level may comprise negative feedback. In some embodiments, a variable comprising a particular potential risk may comprise a positive feedback or negative feedback based on a human and/or user's manual input of positive feedback or negative feedback, and such data of the positive or negative feedback may be used to train the source entity suggestion model. Similarly, each of the variables described herein may comprise positive feedback or negative feedback based on previously tagged variables by humans and/or users of the system, which in turn, may be used to train the source entity suggestion model to determine the best source entity to present to a potential recipient (e.g., those source entities comprising the highest positive feedback scores).

As shown in block 620, the process flow 600 may include the step of generating, based on the collected plurality of previously tagged variables, a previously tagged variable training dataset. In some embodiments, the system may generate, based on the plurality of previously tagged variables, a training dataset comprising each of the previously tagged variables. The training dataset may be input into the source entity suggestion model in order to train the source entity suggestion model to determine the best source entities to present to a user/recipient based on the positive and negative feedback of each variable.

As shown in block 630, the process flow 600 may include the step of applying the previously tagged variable training dataset to the source entity suggestion model to train the source entity suggestion model. In some embodiments, the system may train the source entity suggestion model by applying the previously tagged variable training dataset, such that the source entity suggestion model may determine which variables of each source entity it considers in the future may comprise positive or negative feedback. Based on each of the positive or negative feedbacks for the variable(s) of the future source entities considered by the source entity suggestion model, the source entity suggestion model may—in turn—determine which source entity for a potential recipient comprises the highest or most positive feedback results for the associated variables. Thus, and based on the source entity that comprises the highest positive feedback results for the associated variables, the source entity suggestion model may output the best and/or a plurality of the best source entities from which the user/potential recipient may choose from, much like the process described with respect to FIG. 3 in generating a suggested source entity interface component.

FIG. 7 illustrates an exemplary process flow 700 for training and using a categorization machine learning model, in accordance with an embodiment of the invention. As described previously, some or all of the steps of process flow 700 may be performed by the system 106 (“the system”) in conjunction with the processing application module 144, via the network 140, as described with respect to FIG. 2. In some embodiments, and as described above, the process flow 700 may be performed by the system 106 in conjunction with source entity evaluation system 210, in conjunction with supplier system 106, communication network 240 (or network 140), and/or entity terminal system 230, as shown in FIG. 2.

In some embodiments, and as shown in block 710, the process flow 700 may include the step of applying the at least one supplier entity name to a categorization machine learning model and at least one resource line item. In some embodiments, block 710 may follow block 330 of process flow 300. In some embodiments, the categorization machine learning model may be trained to determine a normalized supplier entity name and an associated category. For instance, the categorization machine learning model may be trained to look for a plurality of categorization variables associated with a received supplier entity name, where the categorization variables may comprise at least one of a general ledger code, a transaction date, a source organization, a source process center, and/or a source facilities type. Based on each of the categorization variables, the categorization machine learning model may determine a likely category and a likely normalized supplier entity name the supplier entity should be associated with. The training of such a categorization machine learning model is described in more detail below with respect to blocks 730, 740, and 750.

In some embodiments, a supplier entity name and at least one resource line item of a received resource file (such as a supplier entity name that does not match an authenticated supplier entity name) may be applied to the categorization machine learning model, such that the categorization machine learning model may determine a normalized supplier entity name based on both the received supplier entity name and the at least one resource line item. For instance, and in some embodiments, the categorization machine learning model may be trained to analyze the supplier entity name as compared against a plurality of similar authenticated supplier entity names, analyze the at least one resource line item of the resource file to determine at least one service and/or product offered by the source entity, analyze other such data of the resource file, and/or the like. Such other data of the resource file may comprise other data associated with the resource transaction, such as a transaction date (e.g., the date the product was received and/or the date services were rendered), a general ledger code (e.g., a unique identifier generated by the recipient user to identify the supplier entity based on the recipient's inventory system), a source organization (e.g., the supplier entity name that supplied the product or service or a source organization type, such as a healthcare organization or educational organization), a source process center (e.g., a particular process center or facility from which the product or service originated from), and/or a source facilities type (e.g., a hospital, laboratory, an educational facility, a commercial or industrial facility, an office building, and/or the like). Thus, and based on the resource transaction data, the source entity name, and the resource line item of the resource file, the categorization machine learning model may generate or output a normalized supplier entity name.

In some embodiments, and as shown in block 720, the process flow 700 may include the step of outputting, by the categorization machine learning model, the normalized supplier entity name and an associated category of the normalized supplier entity name. Thus, and for instance, the categorization machine learning model may output a previously identified normalized supplier entity name and/or a new normalized supplier entity name, along with an associated category.

In some embodiments, the categorization machine learning model may determine or output the normalized supplier entity name based on identifying an authenticated supplier entity name that closely resembles the received supplier entity name, and which comprises most of the same resource transaction data from the resource file (e.g., the same or similar resource line item, the same general ledger code, the same source organization, the same source process center, and/or the same or similar source facilities type). Thus, the categorization machine learning model may be trained to look for matching resource transaction data of the resource file and similar authenticated source entity names as the received source entity name and received resource transaction data, such that a normalized suppler entity name that matches an already-authenticated supplier entity name may be output. Similarly, and based on the already-authenticated supplier entity name, the normalized supplier entity name may also be associated with the category of the already-authenticated supplier entity name.

In some embodiments, and where there are no similar authenticated source entity names and there are not the same or similar resource transaction data as the resource file, the system (e.g., the categorization machine learning model) may generate a new normalized supplier name with all the data determined by the categorization machine learning model as being important (e.g., supplier entity name of the resource file, the resource line item(s), the general ledger code, the source organization, the source process center, and/or the source facilities type) when generating the normalized supplier entity name and determining the appropriate category for the normalized supplier entity name. In this manner, the categorization machine learning model may be trained to output new normalized supplier entity names that do not match an already authenticated supplier entity names, such that the new normalized supplier entity name may be used to generate a newly authenticated supplier entity name for the supplier entity management database.

Further, the categorization machine learning model may also output a previously identified category to be associated with the new normalized supplier entity name (e.g., where the resource transaction data and resource line item(s) match previously identified resource transaction data and resource line item(s) of an already identified category), or the categorization machine learning model may output a new categorization for the new normalized supplier entity name (e.g., where the resource transaction data and resource line item(s) do not match previously identified resource transaction data and resource line item(s) for previously identified categories). Thus, the categorization machine learning model may also be trained to generate new categories for normalized supplier entity names.

In some embodiments, and as shown in block 730, the process flow 700 may include the step of collecting a plurality of categorization variables associated with a plurality of supplier entity names, wherein the categorization variables comprise at least one of a general ledger code, a transaction date, a source organization, a source process center, or a source facilities type. In some embodiments, the system 106 may collect a plurality of categorization variables, such as variables associated with a plurality of resource transactions from a plurality of supplier entities, which may include but are not limited to a general ledger code (a unique identifier of a supplier entity which are generated by a recipient entity and are unique to each recipient entity), a transaction date, a source organization (e.g., a source entity), a source process center, a source facilities type, and/or the like. Based on the plurality of categorization variables collected from a plurality of resource transactions from a plurality of source entities, the system may generate a categorization training dataset that may be source entity-agnostic, recipient-agnostic, and resource transaction-agnostic, such that the categorization machine learning model can be used across different source entities, recipients, and resource transactions.

In some embodiments, and as shown in block 740, the process flow 700 may include the step of generating a categorization training dataset, wherein the categorization training dataset comprises the plurality of categorization variables. By way of non-limiting example, the system 106 may generate the categorization training dataset to comprise all the categorization variables collected at block 730, which are associated with a plurality of source entity names, a plurality of resource transactions, and a plurality of recipients. Thus, and upon generating the categorization training dataset, the system 106 may apply the categorization training dataset to the categorization machine learning model for training.

In some embodiments, and as shown in block 750, the process flow 700 may include the step of applying the categorization training dataset to the categorization machine learning model to train the categorization machine learning model. Thus, and as described above, the categorization training dataset may be applied to the categorization machine learning model in order to train the categorization machine learning model on a plurality of categorization variables in order to output a normalized supplier entity name and an associated category.

FIG. 8 illustrates a graphical interface 800 of the various category types for a category file of the system 106 of FIG. 1. As illustrated by FIG. 8, the category files 810 may comprise category types such as laundry and line services 810a; transcription and dictation services 810b; waste management 810c; parking, shuttle and valet services 810d; survey services-satisfaction 810e; lithotripsy services 810f; blood products and related services 810g; staffing-clinical 810h; transport-emergency medical 810i; perfusion services 810j; medical and industrial gases 810k; distribution-office supplies 8101; eLearning/Education 810m; and/or food service concessions 810n; FIG. 8 also illustrates variable data 830 on a scale for each of the category types 810a-810n. It should be understood that the above-described category files are exemplary and any other category files can be adopted in various embodiments of this disclosure.

The user also may fill out a request for proposal (RFP) or a request for information (RFI) forms for customers in electronic format to enable the user to respond to the questions, wherein the questions may be general or specific questions about the source entity's (supplier's) capabilities. In this way, the source entity (supplier) may also provide REP/RFI forms on their sites, so the supplier management database may update the REP/RFI on the source entities/suppliers' sites in a synchronized manner. Therefore, the cost analysis module may analyze the REP/RFI forms from the customers in accordance with the REP/RFI forms form the source entities (suppliers), during which point the source entities/suppliers' responses are appropriately compiled into the appropriate portion of the REP/RFI forms from the customers.

In some embodiments, the system may receive a user identifier and at least one electronic record associated with the user. By way of non-limiting example, the system may receive a user identifier by identifying the user account associated with the user upon the user entering their user account credentials. In some embodiments, the user identifier may comprise a unique string of alphanumeric characters, a unique bit string, and/or the like, which the system may use to uniquely identify the user account and associated user.

The system may further receive at least one electronic record associated with the user, upon receiving or identifying the user identifier. The electronic records as used herein may refer to at least one contract previously entered into by the user, such as a contract between the user and at least one supplier entity (i.e., source entity). For instance, the system may receive at least one electronic record between the user and a specific supplier entity (source entity) by accessing a database and/or repository of all the electronic records associated the user/client, which may comprise all the electronic records entered into with a plurality of supplier entities (source entities). In some embodiments, the electronic records may comprise at least one source entity response, where such a source entity response (or supplier entity response) may refer to a source entity confirming or accepting the electronic record (e.g., accepting a contract, which may comprise a cost of the services or products contract and/or a cost per unit from the contract). In some embodiments, the source entity response may comprise a plurality of source entity responses, where the plurality of source entity responses may comprise communications tracked between the user/client and the source entity to execute the electronic record (e.g., complete the contract agreement).

In some embodiments, the system may update a predictive plan database with the at least one electronic record, wherein the predictive plan database comprises a plurality of electronic records associated with a plurality of recipients and a plurality of source entities. In some embodiments, a predictive plan database may comprise all the electronic records for a plurality of recipients associated with the source entity evaluation system (e.g., tracked by the source entity evaluation system) and a plurality or source entities (supplier entities) associated with the source entity evaluation system.

In some embodiments, the system may determine a previous transaction amount for each of the plurality of electronic records, wherein the previous transaction amount is based on at least one previous pre-determined variable standard for each source entity. In some embodiments, the source entity evaluation system system may determine a previous transaction amount for each of the plurality of electronic records (e.g., a cost of a previous contract) by assessing each of the plurality of electronic records, such as by a natural language processor and/or by the source entity suggestion model.

In some embodiments, the previous transaction amount(s) are based on at least one previous pre-determined variable standard, where the pre-determined variable standard may refer to a quality standard of each of the source entities (or each of the supplier entities). For instance, such a quality standard may comprise a quality of the products or services offered by each of the source entities (supplier entities). Thus, and in some embodiments, the previous transaction amount of the plurality of electronic records may be based and/or determined at least in part on the previous pre-determined variable standard for the source entity (e.g., the greater the previous pre-determined variable standard or greater the quality standard, the higher the previous transaction amount may be).

In some embodiments, the system may determine, based on the previous pre-determined variable standard and the previous transaction amount associated with each source entity of the plurality of source entities, at least one suggested source entity name which complies with the pre-determined variable standard and the transaction amount. In some embodiments, the source entity evaluation system may determine at least one suggested source entity name (or supplier entity name) that abides by or complies with the pre-determined variable standard associated with the user identifier (i.e., generated by the user as a quality standard to be complied with when determining a source entity). For instance, the source entity evaluation system may compare the at least one previous pre-determined variable standard of at least one source entity to the pre-determined variable standard, where in the instance the previous pre-determined variable standard meets the pre-determined variable standard (e.g., the previous quality standard of the source entity meets the quality standard of the user), the source entity evaluation system may determine the at least one source entity is the at least one suggested source entity name. In some embodiments, the at least one suggested source entity name may further be based on whether the previous transaction amount associated with the source entity complies with the transaction amount generated by the user. In some embodiments, the at least one suggested source entity name may comprise a plurality of suggested source entity names, where the plurality of suggested source entity names comprises a previous transaction amount that complies with the transaction amount and comprises a previous pre-determined variable standard that meets or complies with the pre-determined variable standard.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s). The computer program product comprises a non-transitory computer-readable storage medium having computer-executable instructions.

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more or different elements, which are disclosed herein even when not initially claimed in such combinations.

Thus, specific embodiments and applications of a method for using a machine learning algorithm and a natural language processing to categorize service suppliers have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims, therefore, include not only the combination of elements which are literally set forth but all equivalent structure, material or acts for performing substantially the same function in substantially the same way to obtain substantially the same result. In this sense, it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub combination or variation of a sub combination.

What is claimed is:

1. A system for using machine learning to categorize and select suggested source entities, the system comprising:
a memory device with computer-readable program code stored thereon;
at least one processing device operatively coupled to the at least one memory device and the at least one communication device, wherein executing the computer-readable code is configured to cause the at least one processing device to:
receive a resource file from a user, the resource file comprising at least one supplier entity name and at least one resource line item;
sort at least one resource line item in the resource file based on the at least one supplier entity name;
normalize the at least one supplier entity name to generate at least one normalized supplier entity name;
determine the at least one normalized supplier entity name matches an authenticated supplier entity name of an entity name master record;
update, based on the normalized supplier entity name, a source entity management database, wherein the source entity management database comprises a plurality of authenticated supplier entity names and a plurality of previous variable data for each of the authenticated supplier entity names and at least one updated variable data for the normalized supplier entity name;
receive a user indication, wherein the user indication comprises at least one pre-determined variable standard and a selected category;
apply the at least one pre-determined variable standard and the selected category to a source entity suggestion model to output at least one suggested source entity name that matches the pre-determined variable standard and the selected category; and
generate, based on the at least one suggested source entity name, a suggested source entity interface component to configure a graphical user interface of a user device associated with the user.

2. The system of claim 1, wherein, in an instance where the at least one normalized supplier entity name matches an authenticated supplier entity name, categorize the at least one supplier entity name in an identified category associated with the authenticated supplier entity name.

3. The system of claim 1, wherein the processing device is further configured to:
receive at least one resource agreement between a supplier entity and the user; and
apply an agreement engine to the at least one resource agreement, wherein the agreement engine outputs at least one key performance indicator of the resource agreement and automatically updates the source entity management database with the key performance indicators,
wherein at least one key performance indicator is at least one updated variable data for the supplier entity.

4. The system of claim 1, wherein, in an instance where at least one supplier entity name does not match an authenticated supplier entity name, apply a supplier entity name machine learning model to the at least one supplier entity name.

5. The system of claim 4, wherein, in the instance where the at least one supplier entity name does not match an authenticated supplier entity name, the at least one processing device is further configured to:
search the at least one supplier entity name in a user database, the user database comprising a plurality of authenticated supplier entity names and at least one associated category for each authenticated supplier entity name of the user database;
generate a determined result based on the at least one supplier entity name matching at least one authenticated supplier entity name of the user database;
categorize the at least one supplier entity name based on the associated category for the matched authenticated supplier entity name of the user database; and
determine, based on the associated category, a normalized supplier entity name.

6. The system of claim 4, wherein, in the instance where the at least one supplier entity name does not match an authenticated supplier entity name, the at least one processing device is further configured to:
submit the at least one supplier entity name to a search engine via an application programing interface to generate a search result;
download the search result from the application programming interface;
apply a natural language processor to the search result to generate at least one keyword from the search result;
determine, based on the at least one keyword from the search result, a category associated with the at least one keyword, wherein the category is associated with a plurality of keywords including the at least one keyword; and
determine, based on the category associated with the supplier entity name, the normalized supplier entity name.

7. The system of claim 1, wherein the source entity suggestion model comprises a bayes theorem.

8. The system of claim 1, wherein the source entity suggestion model is a machine learning model, the processing device is further configured to:
collect a plurality of previously tagged variables, wherein the plurality of previously tagged variables comprises at least one of a positive feedback or a negative feedback;
generate, based on the collected plurality of previously tagged variables, a previously tagged variable training dataset; and
apply the previously tagged variable training dataset to the source entity suggestion model to train the source entity suggestion model.

9. The system of claim 1, wherein the at least one processing device is further configured to categorize the at least one normalized supplier entity name as a medical device manufacturer or a medical equipment manufacturer.

10. The system of claim 1, wherein the resource line item comprises data of at least one of a supplier's name, a service type of a supplier of the supplier entity name, an amount owed to the supplier, a due date of payment to the supplier, at least one payment term, or a balance due to the supplier.

11. The system of claim 1, wherein the entity name master record comprises a plurality of authenticated supplier entity names and at least one category for each authenticated supplier entity name, and wherein the normalized supplier entity name is matched to at least one authenticated supplier entity name, and wherein the plurality of authenticated supplier entity names comprises a plurality of entity types for each authenticated supplier entity name.

12. The system of claim 1, wherein the processing device is further configured to:
receive a user identifier and at least one electronic record associated with the user;
receive at least one source entity response from at least one source entity;
update a predictive plan database with the at least one electronic record, wherein the predictive plan database comprises a plurality of electronic records associated with a plurality of recipients and a plurality of source entities;
determine a previous transaction amount for each of the plurality of electronic records, wherein the previous transaction amount is based on at least one previous pre-determined variable standard for each source entity; and
determine, based on the previous pre-determined variable standard and the previous transaction amount associated with each source entity of the plurality of source entities, at least one suggested source entity name which complies with the pre-determined variable standard and the transaction amount.

13. The system of claim 1, wherein each authenticated supplier entity name comprises an integer-based supplier name identifier.

14. The system of claim 1, wherein the processing device is further configured to:
store, by an electronic record management module, a plurality of electronic records associated with each source entity of the plurality of authenticated source entity names, wherein the plurality of electronic records comprise data associated with each resource transaction.

15. The system of claim 1, wherein the variable data comprises data associated with at least one of a location, a service level, a service type, a transaction amount, a service term, a special amount discount, or a potential risk.

16. The system of claim 1, wherein the generation of the at least one normalized supplier entity name is generated by the processing device being further configured to:
apply the at least one supplier entity name to a categorization machine learning model and at least one resource line item; and
output, by the categorization machine learning model, the normalized supplier entity name and an associated category of the normalized supplier entity name.

17. The system of claim 1, wherein the processing device is further configured to:
collect a plurality of categorization variables associated with a plurality of supplier entity names, wherein the categorization variables comprise at least one of a general ledger code, a transaction date, a source organization, a source process center, or a source facilities type;
generate a categorization training dataset, wherein the categorization training dataset comprises the plurality of categorization variables; and
apply the categorization training dataset to the categorization machine learning model to train the categorization machine learning model.

18. The system of claim 1, wherein the processing device is further configured to:
providing, by an entity terminal module, user data associated with at least one authenticated supplier entity name, wherein the user data comprises at least a username and at least one user record, and wherein the at least one user record comprises at least one completed resource transfer or service transfer between the username and an authenticated service entity name.

19. A computer program product for using machine learning to categorize and select suggested source entities, wherein the computer program product comprises at least one non-transitory computer-readable medium having computer-readable program code portions embodied therein, the computer-readable program code portions which when executed by a processing device are configured to cause the processor to:
receive a resource file from a user, the resource file comprising at least one supplier entity name and at least one resource line item;
sort at least one resource line item in the resource file based on the at least one supplier entity name;
normalize the at least one supplier entity name to generate at least one normalized supplier entity name;
determine the at least one normalized supplier entity name matches an authenticated supplier entity name of an entity name master record;
update, based on the normalized supplier entity name, a source entity management database, wherein the source entity management database comprises a plurality of authenticated supplier entity names and a plurality of previous variable data for each of the authenticated supplier entity names and at least one updated variable data for the normalized supplier entity name;
receive a user indication, wherein the user indication comprises at least one pre-determined variable standard and a selected category;
apply the at least one pre-determined variable standard and the selected category to a source entity suggestion model to output at least one suggested source entity name that matches the pre-determined variable standard and the selected category; and
generate, based on the at least one suggested source entity name, a suggested source entity interface component to configure a graphical user interface of a user device associated with the user.

20. A computer-implemented method for using machine learning to categorize and select suggested source entities, the computer-implemented method comprising:
receiving a resource file from a user, the resource file comprising at least one supplier entity name and at least one resource line item;
sorting at least one resource line item in the resource file based on the at least one supplier entity name;
normalizing the at least one supplier entity name to generate at least one normalized supplier entity name;
determining the at least one normalized supplier entity name matches an authenticated supplier entity name of an entity name master record;
updating, based on the normalized supplier entity name, a source entity management database, wherein the source entity management database comprises a plurality of authenticated supplier entity names and a plurality of previous variable data for each of the authenticated supplier entity names and at least one updated variable data for the normalized supplier entity name;
receiving a user indication, wherein the user indication comprises at least one pre-determined variable standard and a selected category;
applying the at least one pre-determined variable standard and the selected category to a source entity suggestion model to output at least one suggested source entity name that matches the pre-determined variable standard and the selected category; and
generating, based on the at least one suggested source entity name, a suggested source entity interface component to configure a graphical user interface of a user device associated with the user.
